(19) United States
(12) Patent Application Publication
(10) Pub. No.: US 2018/0276412 A1
(43) Pub. Date: Sep. 27, 2018

(54) METHOD AND SYSTEM FOR THE PROTECTION OF CONFIDENTIAL ELECTRONIC DATA

(71) Applicant: Deutsche Telekom AG, Bonn (DE)

(72) Inventors: Thomas Unterschuetz, Weiterstadt (DE); Matthias Gerstmeyr, Hemsbach (DE); Swen Gonsberg, Erbes-Buedesheim (DE); Bernd Fondermann, Frankfurt am Main (DE)

(21) Appl. No.: 15/763,461

(22) PCT Filed: Sep. 12, 2016
(86) PCT No.: PCT/EP2016/071460

§ 371 Date: Mar. 27, 2018

(30) Foreign Application Priority Data
Oct. 16, 2015 (DE) 10 2015 117 680.7
Oct. 16, 2015 (EP) 15190246.7

(51) Int. Cl. G06F 21/62; H04L 9/08

(52) U.S. Cl. CPC G06F 21/6254; H04L 2209/16; H04L 9/0816

(57) ABSTRACT

A method for protection of electronic data includes: identifying, by a processor, data of the electronic data that are associable with a person; obscuring, by the processor, the data of the electronic data associable with a person using a first cryptographic key; causing, by the processor, the electronic data with the data obscured using the first cryptographic key to be stored; and in response to the first cryptographic key no longer being considered secure, obscuring, by the processor, the data obscured using the first cryptographic key using a second cryptographic key.

### CROSS-REFERENCE TO RELATED APPLICATIONS

This application is a U.S. National Phase application under 35 U.S.C. § 371 of International Application No. PCT/EP2016/071460, filed on Sep. 12, 2016, and claims benefit to German Patent Application No. DE 10 2015 117 680.7, filed on Oct. 16, 2015, and European Patent Application No. 15190246.7, filed on Oct. 16, 2015. The International Application was published in German on Apr. 20, 2017 as WO 2017/063803 A1 under PCT Article 21(2).

### FIELD

The invention relates to a method and a system for the protection of confidential electronic data.

### BACKGROUND

The term “Big Data” refers to the complex of technologies that are used to collect and analyze large amounts of data, as well as the large amounts of data themselves. The amounts of electronic data generated within the scope of Big Data are generally too large or too complex or are subject to too rapid changes in order to evaluate them using manual and traditional methods of data processing. The collected data can originate from almost any source: starting with any electronic communication, to data collected via government agencies and companies, to the records of the most varied monitoring systems.

The electronic data and/or documents generated within the scope of Big Data may often contain personal data or data that at least can be traced back to individual persons, i.e. that are associable with an individual person. For reasons of data protection, it may therefore be necessary to anonymize or pseudonymize such personal data, i.e. data that are associable with a person, before further processing and in particular before storing them. The aim of anonymization is here to completely prevent the anonymized personal data from being traced back to the person. Pseudonymization replaces the recognition features of a person with a pseudonym in order to exclude or significantly obstruct recognition. The crucial difference between anonymization and pseudonymization is that in anonymization, the references that originally existed between various personal data of a person are dissolved, whereas in pseudonymization, they are preserved.

Anonymization or pseudonymization of personal data is generally performed using encryption algorithms. The loss of the secrecy of the cryptographic key used for this purpose presents an extremely high risk for data protection. It can also be useful here to renew the cryptographic key from time to time in order to even prevent a potential loss of the secrecy of the cryptographic key.

According to prior art, every time the cryptographic key is changed, it is necessary to access the stored original personal data and to encrypt them again. The previously stored pseudonymized data are then discarded. If the original personal data are no longer available, it might be necessary to also discard the pseudonymized data for reasons of data protection. In this case, both the complete information collected as well as the associated creation of a profile is completely lost.

### SUMMARY

In an exemplary embodiment, the present invention provides a method for protection of electronic data. The method includes: identifying, by a processor, data of the electronic data that are associable with a person; obscuring, by the processor, the data of the electronic data associable with a person using a first cryptographic key; causing, by the processor, the electronic data with the data obscured using the first cryptographic key to be stored; and in response to the first cryptographic key no longer being considered secure, obscuring, by the processor, the data obscured using the first cryptographic key using a second cryptographic key.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic diagram of a method for the protection of confidential electronic data according to one embodiment;

FIG. 2 shows a schematic diagram of a system for the protection of confidential electronic data in the form of a file server according to one embodiment;

FIG. 3 shows a schematic diagram of a method for the protection of confidential electronic data according to another embodiment;

FIG. 4 shows a schematic diagram of the flow of communication in a system for the protection of confidential electronic data according to another embodiment;

FIG. 5 shows a schematic diagram of the flow of communication in a system for the protection of confidential electronic data according to another embodiment;

FIG. 6 shows a schematic diagram of the flow of communication in a system for the protection of confidential electronic data according to another embodiment;

FIG. 7 shows a schematic diagram of the flow of communication in a system for the protection of confidential electronic data according to another embodiment;

FIG. 8 shows a schematic diagram of the flow of communication in a system for the protection of confidential electronic data according to another embodiment; and

FIG. 9 shows a schematic diagram of the flow of communication in a system for the protection of confidential electronic data according to another embodiment.

### DETAILED DESCRIPTION

Exemplary embodiments of the present invention provide an improved method and an improved system for the protection of confidential electronic data, in particular of electronic data generated in the context of Big Data.

According to a first aspect, the invention relates to a method for the protection of electronic data, in particular of electronic data generated in the context of Big Data. The method comprises a step of identifying data of the electronic data that are associable with a person, a step of obscuring the data of the electronic data that are associable with a person using a first cryptographic key, a step of storing the electronic data with the data obscured using the first cryptographic key, and, if the first cryptographic key can no longer be considered safe, a step of obscuring the data obscured using the first cryptographic key using a second cryptographic key.

The method according to the first aspect of the invention allows the reuse of already obscured data that have to be considered compromised, for example, due to the loss of the key used for obscuring, in compliance with data protection. At the same time, the method according to the first aspect of the invention allows to easily regularly change the key used for obscuring. Instead of having to access the electronic original data for this purpose, the electronic data with the already obscured data can advantageously be used, without a costly restoration of the electronic data, for example, by requiring decryption of the obscured data of the electronic data.

In one embodiment of the first aspect of the invention, the method comprises the further step of storing the electronic data with the data obscured using the second cryptographic key.

In one embodiment of the first aspect of the invention, in the step of storing the electronic data with the data obscured using the first cryptographic key, the electronic data with the data obscured using the first cryptographic key are stored in a first electronic storage, and in the step of storing the electronic data with the data obscured using the second cryptographic key, the electronic data with the data obscured using the second cryptographic key are stored in a second electronic storage.

In one embodiment of the first aspect of the invention, before the step of obscuring the data obscured using the first cryptographic key using the second cryptographic key, the method comprises the step of identifying the data of the electronic data obscured using the first cryptographic key.

In one embodiment of the first aspect of the invention, the step of obscuring the identified data that are associable with a person using the first cryptographic key comprises the step of encrypting the identified data that are associable with a person using the first cryptographic key or the step of obscuring the data obscured using the first cryptographic key using the second cryptographic key comprises the step of encrypting the data obscured using the first cryptographic key using the second cryptographic key.

In one embodiment of the first aspect of the invention, the step of obscuring the identified data that are associable with a person using the first cryptographic key comprises the step of applying a key-based hash function to the identified data that are associable with a person using the first cryptographic key or the step of obscuring the data obscured using the first cryptographic key using the second cryptographic key comprises the step of applying a key-based hash function to the data obscured using the first cryptographic key using the second cryptographic key.

In one embodiment of the first aspect of the invention, in the step of obscuring the identified data that are associable with a person using the first cryptographic key, or in the step of obscuring the data obscured using the first cryptographic key using the second cryptographic key, the data are anonymized.

In one embodiment of the first aspect of the invention, in the step of obscuring the identified data that are associable with a person, the data are pseudonymized using the first cryptographic key, or in the step of obscuring the data obscured using the first cryptographic key, using the second cryptographic key.

In one embodiment of the first aspect of the invention, after the step of obscuring the data obscured using the first cryptographic key using the second cryptographic key, the method comprises the further step of deleting the data obscured using the first cryptographic key.

In one embodiment of the first aspect of the invention, after the step of obscuring the data obscured using the first cryptographic key using the second cryptographic key, the method comprises the additional step of storing the electronic data with the data obscured using the first cryptographic key and the second cryptographic key.

In one embodiment of the first aspect of the invention, the first key or the second key is provided by a secure key management unit.

In one embodiment of the first aspect of the invention, the electronic data define a plurality of electronic documents and/or form a continuous data stream.

In one embodiment of the first aspect of the invention, the data of the electronic data that are associable with a person are a name, an identification number, a phone number, an email address, a customer number of a person and/or another data element that is suitable for identifying a person.

In one embodiment of the first aspect of the invention, the key is considered no longer secure if the first key was broken, is no longer secret or a planned key change is pending.

According to a second aspect, the invention relates to a system for the protection of electronic data with a processor that is configured to identify data of the electronic data that are associable with a person, to obstruct the data of the data that are associable with a person using a first cryptographic key, to store the electronic data with the data obstructed using the first cryptographic key in a storage, and, if the first cryptographic key can no longer be considered secure, to obstruct the data obstructed using the first cryptographic key using a second cryptographic key.

In the following detailed description, reference is made to the accompanying drawings that form a part hereof, and in which are shown by way of illustration specific embodiments in which the invention may be practiced. It is understood that other embodiments may be utilized and structural or logical changes may be made without departing from the concept of the present invention. The following detailed description is, therefore, not to be taken in a limiting sense. It is further understood that the features of the different exemplary embodiments described herein can be combined with each other, unless specifically stated otherwise.

The aspects and embodiments are described with reference to the drawings, wherein like reference symbols generally reference like elements. In the following description, for purposes of explanation, numerous specific details are set forth in order to provide a thorough understanding of one or several aspects of the invention. However, for a person skilled in the art, it may be apparent that one or more aspects or embodiments may be carried out with a lesser degree of the specific details. In other instances, well-known structures and elements are shown in schematic form in order to facilitate describing one or more aspects or embodiments. It is understood that other embodiments may be utilized and structural or logical changes may be made without departing from the concept of the present invention.

Devices are described, and methods are described. It is understood that fundamental characteristics of the devices also apply to the methods, and vice versa. Therefore, a duplicate description of such characteristics may have been omitted for brevity.

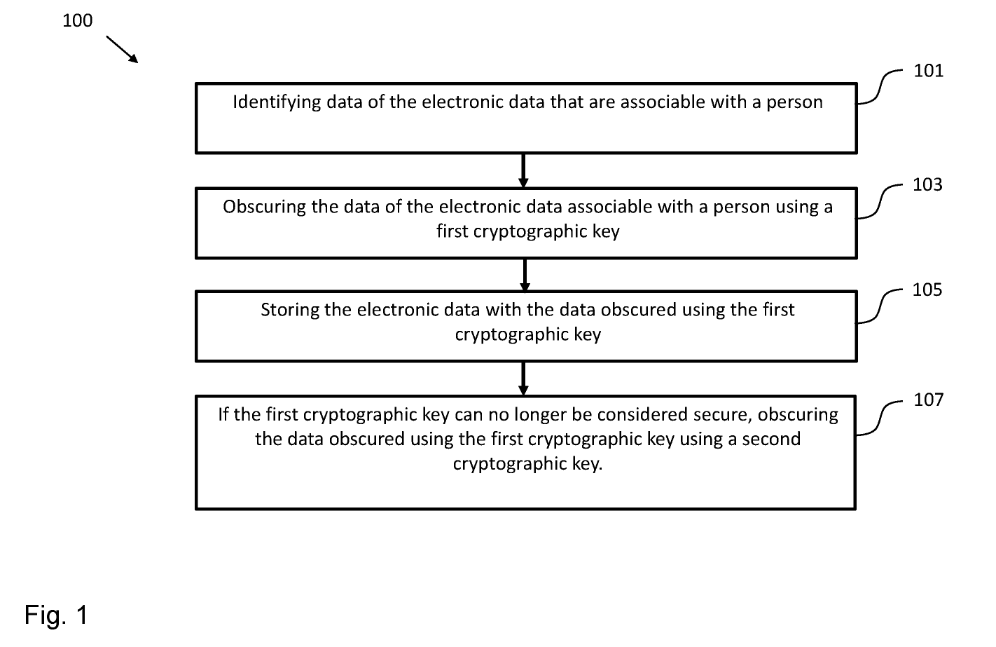

FIG. 1 shows a schematic diagram of a method 100 for the protection of electronic data, in particular of electronic data generated within the scope of Big Data and comprising personal data, i.e. that are associable with a person, according to one embodiment.

The method 100 comprises a step 101 of identifying the data of the electronic data that are associable with a person, which can be performed using suitable search and/or filter algorithms, for example. The data that are associable with a person may be, for example, a name, an identification number, a phone number, an email address, a customer number of a person and/or another data element that is suitable for identifying a person. For example, the electronic data may be available in the form of a plurality of electronic documents, i.e. files, and/or originate from a continuous data steam.

The method 100 comprises a further step 103 of obscuring the data of the electronic data that are associable with a person using a first cryptographic key.

The method 100 comprises a further step 105 of storing the electronic data with the data obscured using the first cryptographic key.

The method 100 comprises a further step 107, if the first cryptographic key can no longer be considered secure, of obscuring the data obscured using the first cryptographic key using a second cryptographic key. For example, this may be the case if the first key was broken, is no longer secret or a planned key change is pending.

According to one embodiment, the electronic data with the data obscured using the second cryptographic key may be stored.

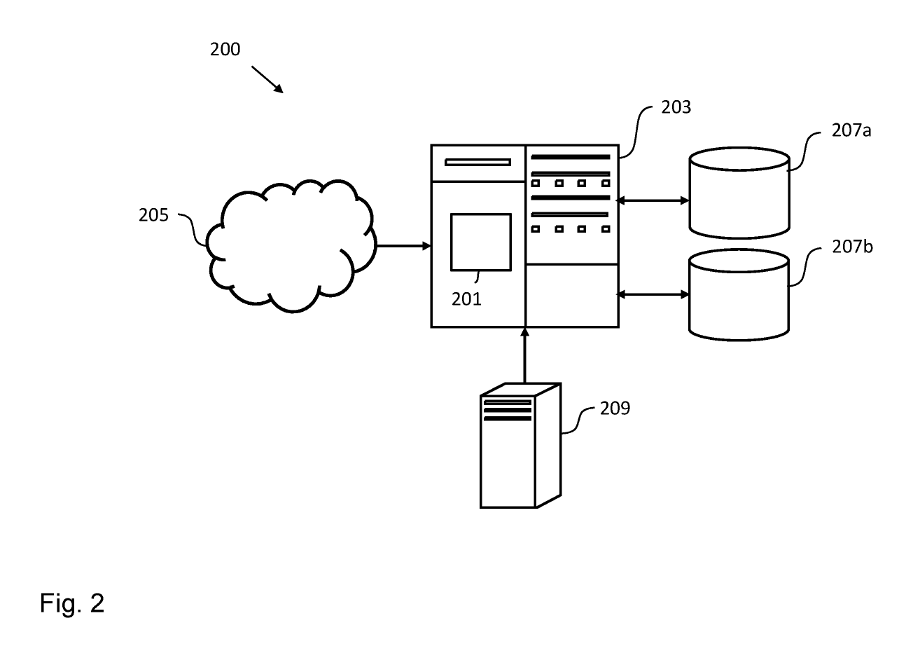

According to one embodiment, in the step of storing 105 the electronic data with the data obscured using the first cryptographic key, these electronic data, i.e. the electronic data with the data obscured using the first cryptographic key, may be stored in a first electronic storage, for example, in the storage 207a shown in FIG. 2, and in the step of storing the electronic data with the data obscured using the second cryptographic key, the electronic data with the data obscured using the second cryptographic key may be stored in a second electronic storage, for example in the storage 207b shown in FIG. 2.

According to one embodiment, before the step of obscuring the data obscured using the first cryptographic key using the second cryptographic key, the method 100 comprises a further step of identifying the data of the electronic data obscured using the first cryptographic key.

According to one embodiment, the step of obscuring 103 the identified data that are associable with a person using the first cryptographic key comprises a step of encrypting the identified data that are associable with a person using the first cryptographic key or the step of obscuring 107 the data obscured using the first cryptographic key using the second cryptographic key, a step of encrypting the data obscured using the first cryptographic key using the second cryptographic key. Any key-based encryption method is suitable for this purpose.

According to one embodiment, the step of obscuring 103 the identified data that are associable with a person using the first cryptographic key comprises a step of applying a key-based hash function to the identified data that are associable with a person using the first cryptographic key or the step of obscuring 107 the data obscured using the first cryptographic key using the second cryptographic key comprises a step of applying a key-based hash function to the data obscured using the first cryptographic key using the second cryptographic key.

According to one embodiment, in the step of obscuring 103 the identified data that are associable with a person using the first cryptographic key, or in the step of obscuring 107 the data obscured using the first cryptographic key using the second cryptographic key, the data are anonymized.

According to one embodiment, in the step of obscuring 103 the identified data that are associable with a person using the first cryptographic key, or in the step of obscuring 107 the data obscured using the first cryptographic key using the second cryptographic key, the data are pseudonymized.

According to one embodiment, after the step of obscuring 103 the data obscured using the first cryptographic key using the second cryptographic key, the method 100 comprises the further step of deleting the data obscured using the first cryptographic key.

According to one embodiment, after the step of obscuring 107 the data obscured using the first cryptographic key using the second cryptographic key, the method 100 comprises a further step of storing the electronic data with the data obscured using the first cryptographic key and using the second cryptographic key.

For example, the method 100 can be carried out by the system 200 for the protection of electronic data shown in FIG. 2. The system 200 comprises a processor 201. The processor 201 may be implemented on a server 203 and be designed in the form of hardware and/or software. In turn, the server 203 may be part of a server farm or data center.

The processor 201 is configured to carry out the method 100 shown in FIG. 1. The file server 203 and/or processor 201 can be supplied with electronic data from a data source 205. The processor 201 is configured to identify personal data and/or data that are associable with a person in these electronic data. The processor 201 is further configured to obscure, in particular to encrypt, the identified data of the electronic data that is associable with a person using a first cryptographic key. For example, the first cryptographic key may be provided by a secure key management unit 209. The processor 201 is further configured to store the electronic data with the data obscured using the first cryptographic key in a storage, for example in the storage 207a shown in FIG. 2 and/or in the storage 207b shown in FIG. 2, in such a way that the personal data in the electronic data are replaced with the obscured personal data. The processor 201 is further configured, if the first cryptographic key can no longer be considered secure, to obscure the data obscured using the first cryptographic key using a second cryptographic key. For example, this may be the case, if the first key was broken, is no longer secret or a planned key change is pending.

This second cryptographic key may also be provided to the processor 201 by the key management unit 209.

Below, further embodiments of the method 100 and the system 200 are described.

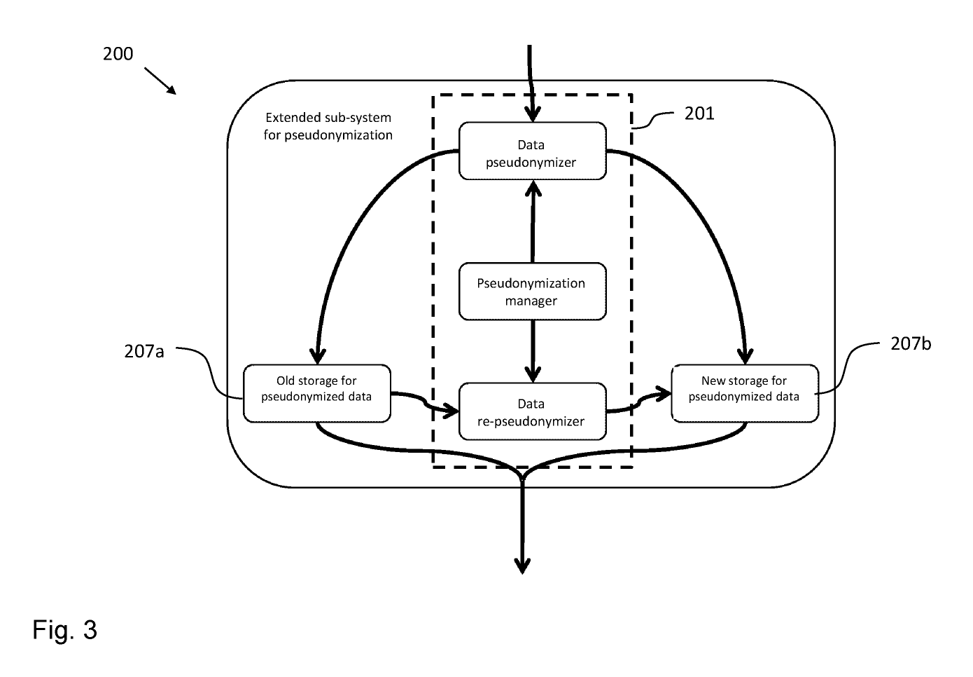

FIG. 3 shows a schematic diagram of another embodiment of the system 200 for the protection of confidential electronic data. In this embodiment, the processor 201 may provide the functionality of a data pseudonymizer, a pseudonymization manager and a data re-pseudonymizer. For example, these can be software modules running on the processor 201.

The data pseudonymizer receives personal data and replaces all personal data with pseudonymized data. The pseudonymized data can then initially be stored in the old storage 207a for pseudonymized data, later also in the new storage 207b for pseudonymized data. The data pseudonymizer transfers the pseudonymized data to the old storage 207a for pseudonymized data. Here, they are persisted and made available for further data processing, if required. Subsequently, the pseudonymized data may also be made available to the data re-pseudonymizer. The pseudonymization manager orchestrates activities for a re-pseudonymization according to the invention following a loss of secrecy of the key or after a planned key change. Moreover, the pseudonymization manager knows all keys described during the further course of the method, e.g., the old key and the new key, and can make them available to the data pseudonymizer and the data re-pseudonymizer.

The data re-pseudonymizer reads from the old storage 207a for pseudonymized data the data already pseudonymized with the old first key, or in the case that the method for re-pseudonymization of large data amounts has already been carried out multiple times, with the old keys, and encrypts them with the new second key a second, or in the case that the method for re-pseudonymization of large personal data amounts has already been carried out multiple times, another time. The re-encrypted data are written in the new storage 207b for pseudonymized data. The data re-pseudonymizer transfers the data pseudonymized again to the new storage 207b for pseudonymized data. Here, they are persisted and made available for data processing, if required.

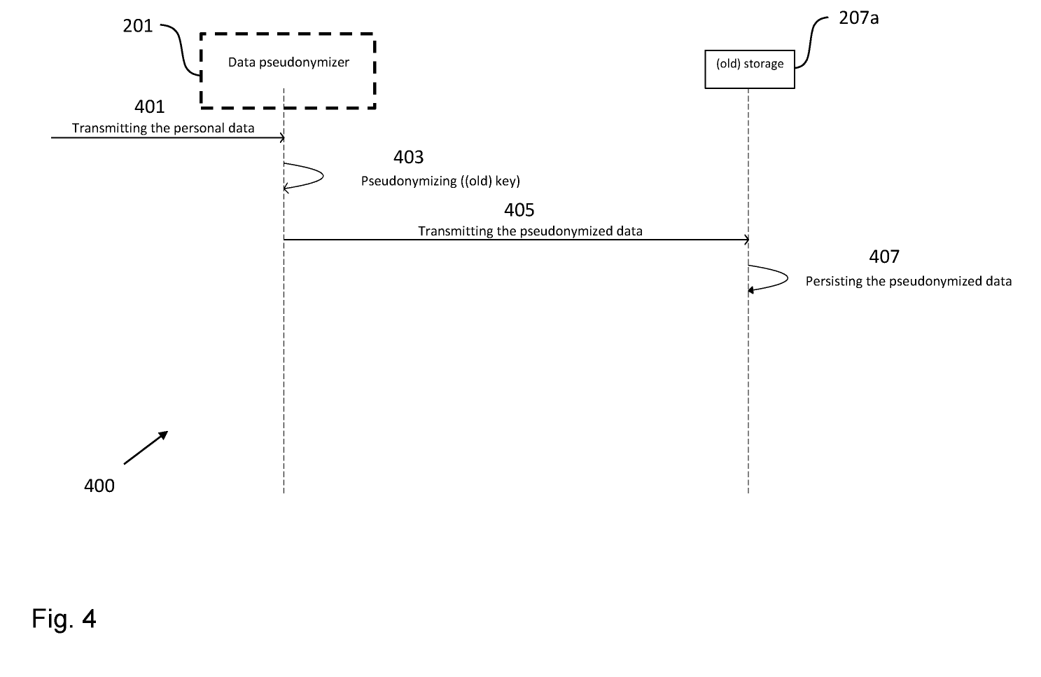

FIGS. 4 to 9 show details of another embodiment of the method 100 for the protection of confidential electronic data based on the embodiment of the system 200 shown in FIG. 3.

FIG. 4 shows a first stage 400 of the method 100, according to another embodiment. Personal data are transmitted to the data pseudonymizer, pseudonymized using a key, and stored in the storage 207a for pseudonymized data. The single key in this method stage is referred to as the “(old) key”, and hereinafter as the “old key”. The same applies to the single storage 207a in this method stage, which is herein referred to as the “(old) storage for pseudonymized data”, and hereinafter as the “old storage for pseudonymized data”. Stage 400 comprises the following individual steps:

401: Transmitting the personal data.

For example, electronic data with personal data are supplied to the data pseudonymizer, which, for example, may be provided by the processor 201 shown in FIG. 2, from the data source 205 shown in FIG. 2.

403: Pseudonymizing with the old key

The personal information in the personal data supplied is identified and obscured, in particular encrypted. The encryption is carried out based on the (old) key. Thus, the personal data are transferred to obscured, in particular pseudonymized data.

405: Transmitting the pseudonymized data

The pseudonymized data are transmitted to the (old) storage 207a for pseudonymized data.

407: Persisting the pseudonymized data

The pseudonymized data are persisted in a database in the (old) storage 207a for pseudonymized data.

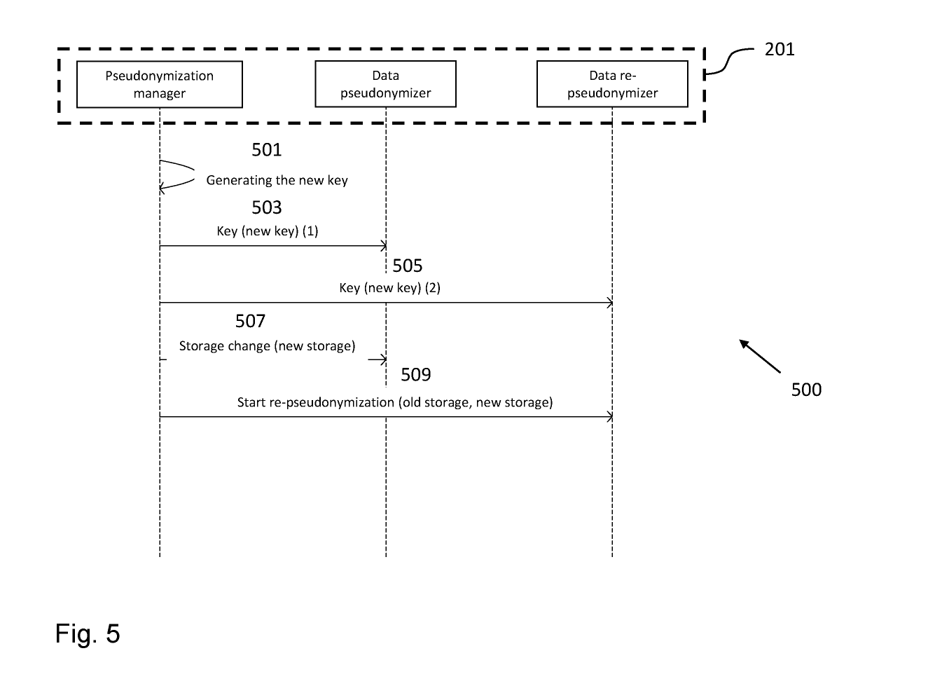

FIG. 5 shows a second stage 500 of the method 100, according to the other embodiment. The second method stage 500 is preceded in that the “old key” used in the first method stage 400 can or shall no longer be used. For example, this is the case due to the loss of the secrecy of the key or caused by a regularly implemented key change. With this method stage 500, the pseudonymization manager starts activities for a key change. In fact, this method stage does not “replace” keys with each other. Rather, another new key is added to the old key. In the case that the method has already been carried out multiple times, another new key is added to the old keys. For example, the new key may be generated by the pseudonymization manager and forwarded to the data pseudonymizer as well as the data re-pseudonymizer. The data pseudonymizer is instructed to henceforth persist pseudonymized data no longer in the old storage 207a for pseudonymized data, but in the new storage 207b for pseudonymized data. The data re-pseudonymizer is instructed to pseudonymize the data of the old storage 207a no longer considered pseudonymized for the reasons mentioned above again and to transfer them to the new storage 207b for pseudonymized data.

Stage 500 comprises the following individual steps:

501: Generating the new key

The pseudonymization manager as part of the processor 201 generates the new key, which is used in the further course of the method for the encryption of data.

503: Key (new key) (1)

The new key is transmitted to the data pseudonymizer.

505: Key (new key) (2)

The new key is transmitted to the data re-pseudonymizer.

507: Storage change (new storage)

The data pseudonymizer is instructed to henceforth persist the pseudonymized data in the new storage 207b.

509: Start re-pseudonymization (old storage, new storage)

The data re-pseudonymizer is instructed to pseudonymize the data existing in the old storage 207a again and to persist them in the new storage 207b.

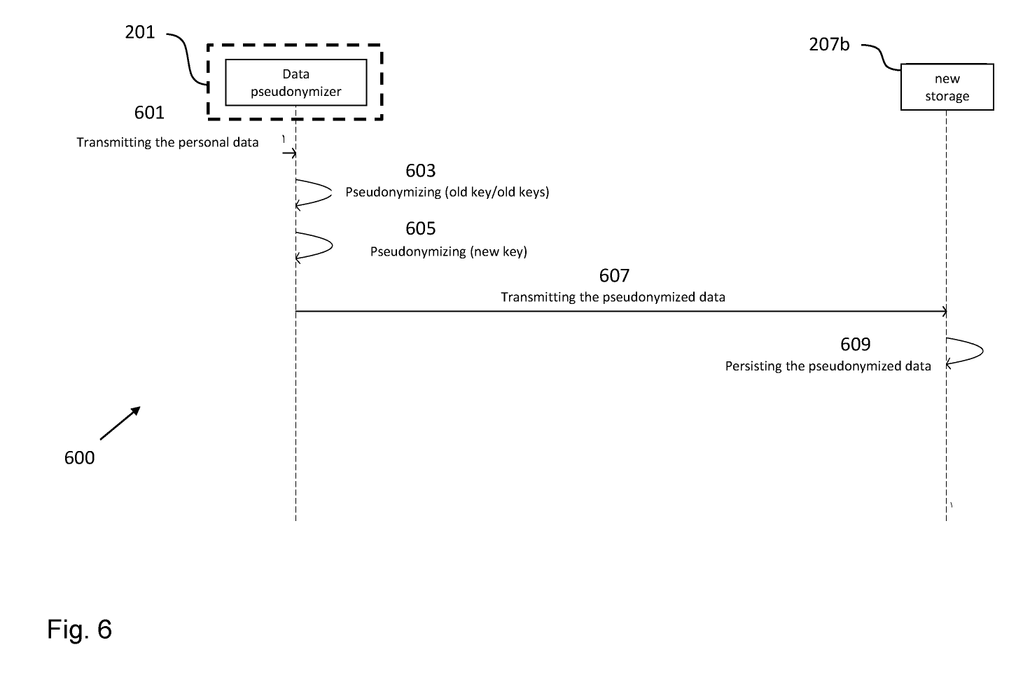

FIG. 6 shows a third stage 600 of the method 100, according to the other embodiment. Generated personal data are transmitted to the data pseudonymizer. Using the old key, the personal data are encrypted as in method stage 400. If the method has already been carried out multiple times, the data are encrypted using the old keys as in method stage 400. However, for the reasons mentioned above, the encrypted data cannot be considered pseudonymized. Therefore, they are encrypted again, this time with the new key. The original and now twice encrypted data are now pseudonymized. However, the pseudonymized data are no longer stored in the old storage 207a for pseudonymized data, but rather in the new storage 207b for pseudonymized data. This storage change was initiated by calling the message storage change (new storage) from method stage 500.

Stage 600 comprises the following individual steps:

601: Transmitting the personal data

For example, electronic data with personal data are supplied to the data pseudonymizer, which, for example, may be provided by the processor 201 shown in FIG. 2, form the data source 205 shown in FIG. 2.

603: Pseudonymizing (old key/old keys)

The personal information in the personal data supplied is identified and encrypted. The encryption is carried out based on the old key. Thus, the personal data are transferred to pseudonymized data. If this method run was already preceded by method runs, then the already pseudonymized information that can now no longer be considered pseudonymized for the reasons mentioned above is identified and encrypted again. This is carried out for each of these method runs with the respective old keys of the method run.

605: Pseudonymizing (new key)

During the last and/or the second pseudonymization shown in FIG. 6, the data are pseudonymized. Only now, the data can be considered pseudonymized.

607: Transmitting the pseudonymized data

The pseudonymized data are transmitted to the new storage 207b for pseudonymized data.

609: Persisting the pseudonymized data

The pseudonymized data are persisted in a database in the new storage 207b for pseudonymized data.

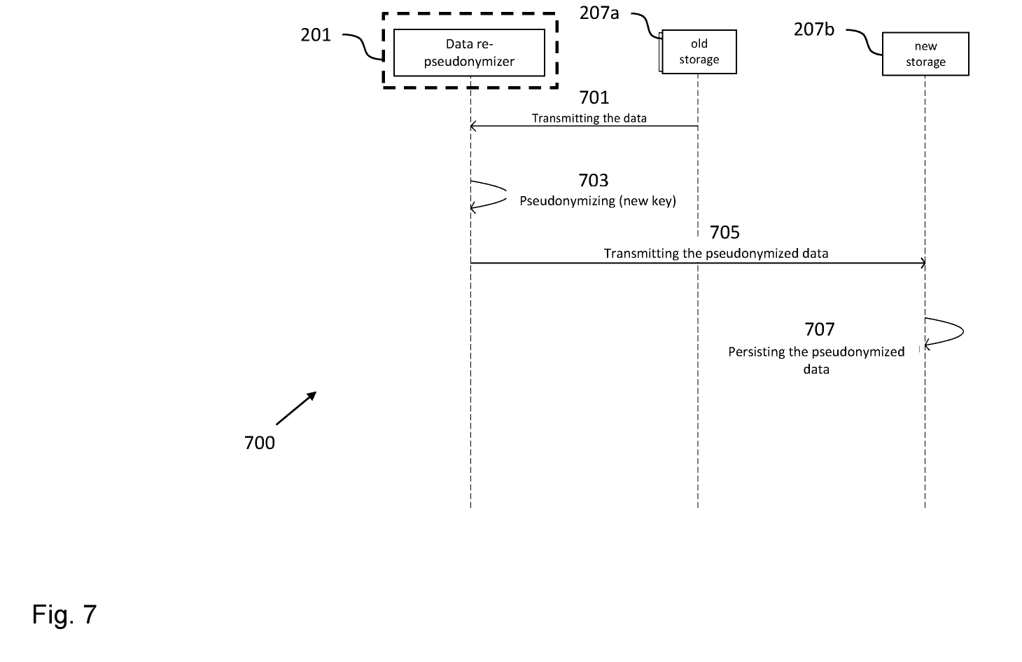

FIG. 7 shows a fourth stage 700 of the method 100, according to the other embodiment. This method stage 700 was initiated by calling the message “Start re-pseudonymization (old storage, new storage)” from method stage 500. Data from the old storage 207a for pseudonymized data that can no longer be considered pseudonymized for the reasons mentioned above are successively removed from the old storage 207a for pseudonymized data. These data are encrypted using an encryption method and using the “new key”. The original data are now encrypted twice and thus pseudonymized. If the method has already been carried out multiple times, the data are now encrypted multiple times and thus pseudonymized. The pseudonymized data are stored in the new storage 207b for pseudonymized data. This method stage 700 is repeated until all pseudonymized data that can no longer be considered pseudonymized for the reasons mentioned above have been encrypted again and thus pseudonymized and transferred to the new storage 207b for pseudonymized data.

Stage 700 comprises the following individual steps:

701: Transmitting the data

The data from the old storage 207a for pseudonymized data that can no longer be considered pseudonymized for the reasons mentioned above are transmitted to the data re-pseudonymizer.

703: Pseudonymizing (new key)

The already pseudonymized information in the supplied data that can now no longer be considered pseudonymized for the reasons mentioned above is identified and encrypted again. The encryption is carried out based on the new key. The data are thus pseudonymized again.

705: Transmitting the pseudonymized data

The pseudonymized data are transmitted to the new storage 207b for pseudonymized data.

707: Persisting the pseudonymized data

The pseudonymized data are persisted in a database in the new storage 207b for pseudonymized data.

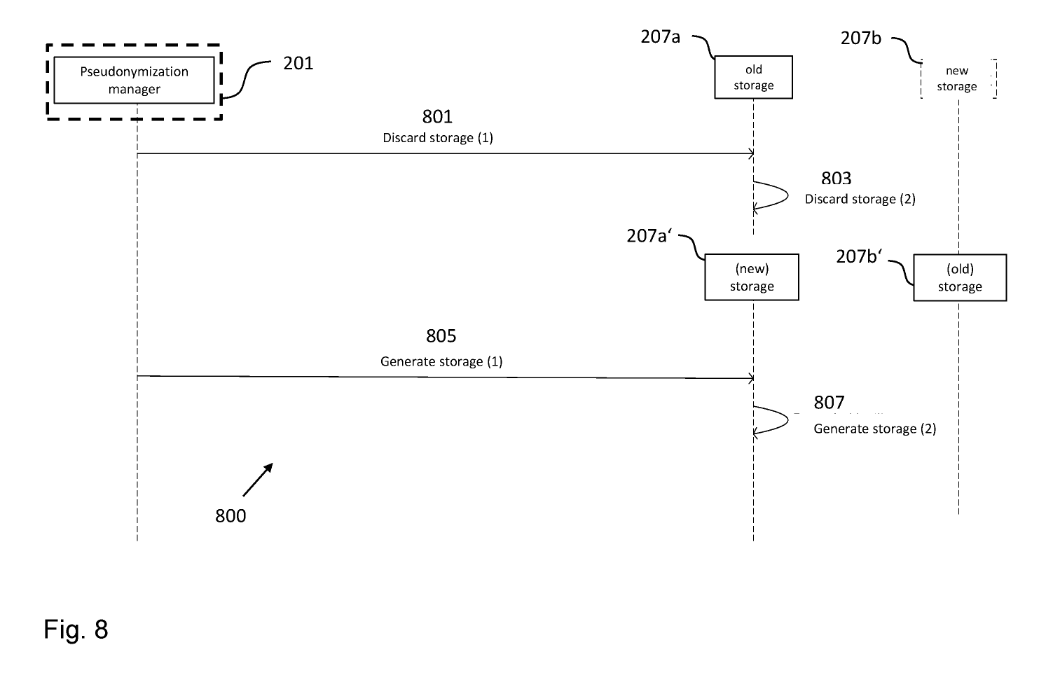

FIG. 8 shows a fifth stage 800 of the method 100, according to the other embodiment. With this last method stage 800, the “old storage” no longer required is discarded. In preparation of a future method run, the new storage, namely the “(new) storage” is generated. By generating the “(new) storage”, the (previously) “new storage” becomes the new “(old) storage”.

Stage 800 comprises the following individual steps:

801: Discard storage (1)

The pseudonymization manager initiates the deletion of the old storage 207a.

803: Discard storage (2)

The old storage 207a is discarded. All data are deleted.

805: Generate storage (1)

The pseudonymization manager initiates the generation and the initialization of the (new) storage 207b.

807: Generate storage (2)

The new storage 207b is generated and initiated.

The method 100 described above can be carried out multiple times for each key change. In this case, the term “new storage” of the preceding method run is to be replaced with the term “old storage” in the new method run. With every new method run, a new “new storage” is created, which is indicated by the numerals 207a′ and 207b′ in FIG. 8.

In particular, the method stage 600 changes when the method is carried out repeatedly. If a method run was already preceded by method runs, then a pseudonymization takes place for each of these method runs with the respective old key of the method run. During the first pseudonymization within the scope of method stage 600, the personal data are identified and pseudonymized. During every additional pseudonymization, the data already pseudonymized are pseudonymized again.

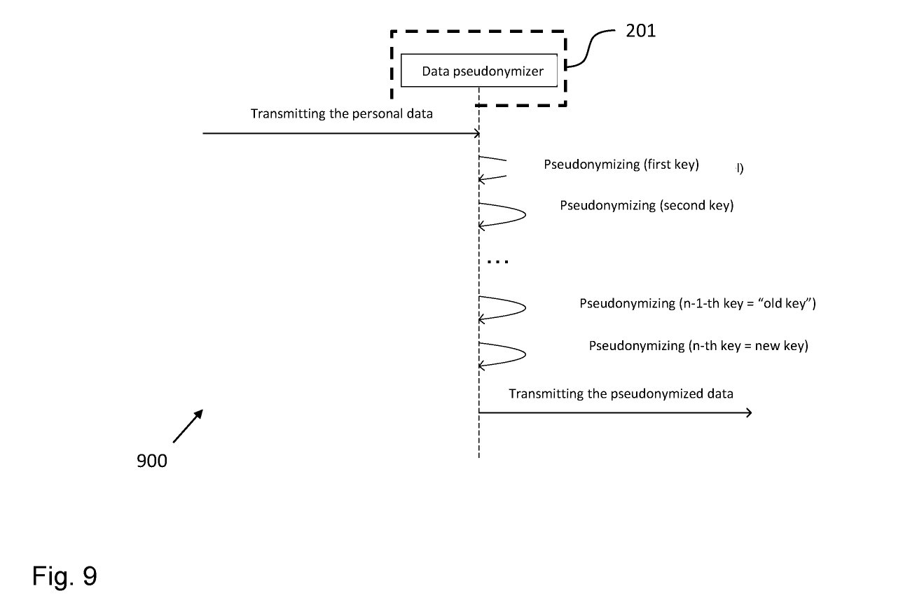

FIG. 9 shows a schematic diagram of the method stage during pseudonymization during the n-th method run. In this case, the term “old keys” used in plural refers to the 1st to (n−1)-th key. In this case, the term “old key” refers to the (n−1)-th key. The term “new key” refers to the n-th key.

In the further embodiments of the method 100 and the system 200 described above in conjunction with FIGS. 3 to 9, the personal data are pseudonymized. However, this merely represents a special embodiment of the system and method. In other embodiments, the personal data can also be obscured in other ways, e.g., anonymized.

In the further embodiments of the method 100 and the system 200 described above in conjunction with FIGS. 3 to 9, the respective new key as well as the old keys are stored by the pseudonymization manager. However, this merely represents a special embodiment. In another advantageous embodiment, the respective new key and the old keys can be stored in a separate key management unit, for example, the key management unit 209 shown in FIG. 2. The key management unit 209 can meet wider security requirements. I

n the further embodiments of the method 100 and the system 200 described above in conjunction with FIGS. 3 to 9, the old storage 207a for pseudonymized data is discarded after a re-pseudonymization. This merely represents a special embodiment. In another advantageous embodiment, this old storage 207a can be retained. A retention can serve the purpose of archiving, for example.

In the further embodiments of the method 100 and the system 200 described above in conjunction with FIGS. 3 to 9, the new storage 207b for pseudonymized data is already available and initialized before the key change. This merely represents a special embodiment. In another advantageous embodiment, the new storage 207b may also be created and initialized at another suitable point in time. Such a point in time would be, for example, before the message “Storage change (new storage)” in method stage 500.

In the further embodiments of the method 100 and the system 200 described above in conjunction with FIGS. 3 to 9, individual datasets are transmitted between the units. This merely represents a special embodiment. In another advantageous embodiment, data may also be transmitted in the form of a continuous data stream.

In the further embodiments of the method 100 and the system 200 described above in conjunction with FIGS. 3 to 9, data are persisted in databases. This merely represents a special embodiment. In another advantageous embodiment, data may also be persisted in another suitable form. Other suitable forms may be, for example, files of a file system.

In the further embodiments of the method 100 and the system 200 described above in conjunction with FIGS. 3 to 9, data are persisted. This merely represents a special embodiment. In another advantageous embodiment, data may also be kept in a transient manner.

In the further embodiments of the method 100 and the system 200 described above in conjunction with FIGS. 3 to 9, data are duplicated from the old storage 207a to the new storage 207b within the scope of the re-pseudonymization. The data thus exist in two different storages. This merely represents a special embodiment. In another advantageous embodiment, data may also be transferred from their original state to the re-pseudonymized state in a single storage. Then, data only exist in a single storage at any given time.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for protection of electronic data, comprising:
identifying, by a processor, data of the electronic data that are associable with a person;
obscuring, by the processor, the data of the electronic data associable with a person using a first cryptographic key;
causing, by the processor, the electronic data with the data obscured using the first cryptographic key to be stored; and
in response to the first cryptographic key no longer being considered secure, obscuring, by the processor, the data obscured using the first cryptographic key using a second cryptographic key,

2. The method of claim 1, wherein the method further comprises:
storing the electronic data with the data obscured using the second cryptographic key.

3. The method of claim 2, wherein the electronic data with the data obscured using the first cryptographic key are stored in a first electronic storage, and wherein the electronic data with the data obscured using the second cryptographic key are stored in a second electronic storage.

4. The method of claim 1, wherein before obscuring the data obscured using the first cryptographic key using the second cryptographic key, the method further comprises:
identifying the data of the electronic data obscured using the first cryptographic key.

5. The method of claim 1, wherein the identified data that are associable with a person using the first cryptographic key comprises encrypting the identified data that are associable with a person using the first cryptographic key; or
wherein obscuring the data obscured using the first cryptographic key using the second cryptographic key comprises encrypting the data obscured using the first cryptographic key using the second cryptographic key.

6. The method of claim 1, wherein the identified data that are associable with a person using the first cryptographic key comprises applying a key-based hash function to the identified data that are associable with a person using the first cryptographic key; or
wherein obscuring the data obscured using the first cryptographic key using the second cryptographic key comprises applying a key-based hash function to the data obscured using the first cryptographic key using the second cryptographic key.

7. The method of claim 1, wherein the data obscured using the first cryptographic key or the data obscured using the second cryptographic key, are anonymized.

8. The method of claim 1, wherein the data obscured using the first cryptographic key or the data obscured using the second cryptographic key are pseudonymized.

9. The method of claim 1, wherein after obscuring the data obscured using the first cryptographic key using the second cryptographic key, the method further comprises:
deleting the data obscured using the first cryptographic key,

10. The method of claim 1, wherein after obscuring the data obscured using the first cryptographic key using the second cryptographic key, the method further comprises:
storing the electronic data with the data obscured using the first cryptographic key and using the second cryptographic key.

11. The method of claim 1, wherein the first key or the second key is provided by a secure key management unit.

12. The method of claim 1, wherein the electronic data define a plurality of electronic documents and/or form a continuous data flow,

13. The method of claim 1, wherein the data of the electronic data that are associable with a person are a name, an identification number, a phone number, an email address, a customer number of a person and/or another data element that is suitable for identifying a person.

14. The method of claim 1, wherein the first key is no longer be considered secure if the first key was broken, is no longer secret or a planned key change is pending.

15. A system for protection of electronic data, comprising:
a storage; and
a processor;
wherein the processor is configured to:
identify data of the electronic data that are associable with a person;
obscure the data of the electronic data associable with a person using a first cryptographic key;
cause the electronic data with the data obscured using the first cryptographic key to be stored in the storage; and
if the first cryptographic key can no longer be considered secure, obscure the data obscured using the first cryptographic key using a second cryptographic key.
